(19) United States
(12) Patent Application Publication
(10) Pub. No.: US 2005/0128067 A1
(43) Pub. Date: Jun. 16, 2005

(54) Automatic sensitivity adjustment on motion detectors in security system

(75) Inventor: David S. Zakrewski, Babylon, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 10/734,032

(22) Filed: Dec. 11, 2003

(51) Int. Cl. G08B 29/00

(52) U.S. Cl. 340/511; 340/309.16

(57) ABSTRACT

The sensitivity of a motion sensor or detector in a security system is adjusted by a remotely-transmitted signal, such as from a user interface device in the security system. In another approach, a pet wears a transmitter on its collar that transmits a wireless signal to command the motion sensor to adjust its sensitivity, e.g., by entering a pet immune mode, when the pet is in the room that is protected by the motion sensor. In another approach, a remote monitoring site sends instructions to the motion sensor via a communication interface. The sensitivity can be adjusted by adjusting a pulse count, optical gain, or electrical or optical sensitivity of the motion sensor.

### BACKGROUND OF THE INVENTION

1. Field of Invention

The invention relates generally to a motion detector for use in a security system and, more particularly, to a motion detector with an adjustable sensitivity.

2. Description of Related Art

Motion sensors are commonly used in security system to detect the presence of an intruder in the home or other building. These sensors commonly use passive infrared (PIR) sensors that detect the body heat of the intruder. Active sensors such as microwave sensors are also used, which transmit a microwave signal and observe the reflected signal. A change in the reflected signal indicates the presence of the intruder. Furthermore, so-called “pet immune” motion sensors have been developed which are desensitized to the presence of a pet such as a dog or cat near the floor of the building. For example, a wall-mounted motion sensor may have one detecting element that receives infrared radiation from different lens portions that are arranged to detect heat from different elevations in a room. The lens portions for the lower elevations are less transmissive to the infrared radiation so that the heat from the pet is not sufficient to trip the gain threshold of the sensor.

In some cases, the motion sensor can be set to adjust the number of pulse counts that are required to trigger an alarm, such as by manual adjustment of a dual inline pole (DIP) switch. However, the adjustments are normally made manually to components that are within a housing of the sensor. Once the housing is closed and the sensor is installed, no further adjustments can be made. Moreover, a trained technician is needed to make the adjustments. This can cause difficulties if the sensitivity needs to be adjusted at a later time. For example, the setting made by the technician may not be optimal. If the sensitivity is too great, the pet will trigger an alarm, and if the sensitivity is too low, a human intruder may not trigger the alarm. Moreover, variations in sensitivity can occur as the sensor ages, or due to environmental factors such as dust. Furthermore, the homeowner may acquire a larger pet, which requires the sensitivity to be reduced. Additionally, the conventional installation procedure is inconvenient.

Accordingly, a solution is need that addresses the above and other issues.

### BRIEF SUMMARY OF THE INVENTION

To overcome these and other deficiencies in the prior art, the present invention provides a motion detector whose sensitivity can be adjusted as needed.

In one aspect of the invention, an apparatus for adjusting the sensitivity of a motion detector includes a transmitter, and a control for controlling the transmitter to transmit a signal for adjusting the sensitivity of the motion detector.

In another aspect of the invention, a motion detector includes a component for sensing electromagnetic radiation that is indicative of the presence of a living being such as a person or pet, a control responsive to the component for determining, in accordance with the sensed electromagnetic radiation, whether to trigger a signal indicating that the living being has been detected, and a receiver for receiving a remotely-generated signal for adjusting a sensitivity of the component. The control is responsive to the remotely-generated signal for adjusting a sensitivity with which the component senses the electromagnetic radiation.

In yet another aspect of the invention, a motion detector includes a component for sensing electromagnetic radiation that is indicative of the presence of a living being, a control responsive to the component for determining, in accordance with the sensed electromagnetic radiation and a decision parameter, whether to trigger a signal indicating that the living being has been detected, and a receiver for receiving a remotely-generated signal for adjusting a sensitivity of the motion detector. The control is responsive to the remotely-generated signal for adjusting the decision parameter.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates an overview of a security system, according to the invention;

FIG. 2 illustrates a remote transmitter, according to the invention;

FIG. 3 illustrates a pet collar with a remote transmitter, according to the invention;

FIG. 4 illustrates a motion sensor with adjustable sensitivity, according to the invention;

FIG. 5 illustrates voltage pulses, and a detection threshold, according to the invention;

FIG. 6 illustrates a circuit for adjusting a detection threshold, according to the invention; and

FIG. 7 illustrates a user interface device for remotely adjusting the sensitivity of a motion sensor, according to the invention.

### DETAILED DESCRIPTION OF THE INVENTION

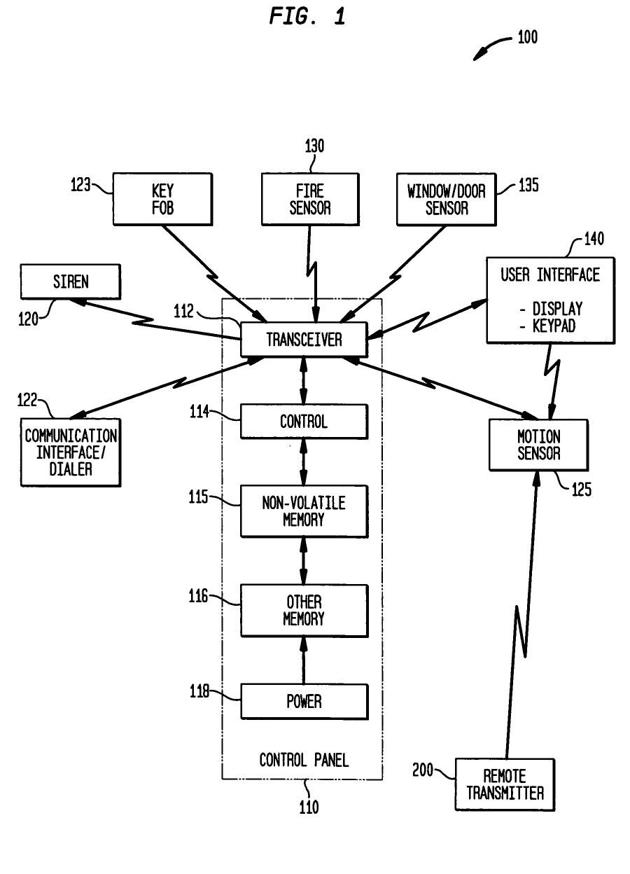

Many buildings today, such as homes and places of businesses, are equipped with security systems to deter burglaries and detect fires and other hazards such as carbon monoxide. FIG. 1 illustrates an overview of a security system 100 according to the invention, which includes a central control panel 110 that communicates with a number of sensors via wired and/or wireless paths. For example, the control panel 110 may receive signals from one or more motion sensors 125 that detect when a person enters a room. Signals received from fire sensors 130, such as smoke or heat sensors, indicate that a fire has been detected. Signals received from window and door sensors 135 indicate that a window or door has been opened.

Signals received from a peripheral user interface device 140, e.g., including a keypad and display, may arm and disarm the system, as well as trip an alarm via a panic button feature. The user interface device 140 may be the primary interface between the human user and the security system 100. The user interface device 140 typically includes components that are analogous to the control panel 110, including a control, memory and power source. Optionally, the user interface device 140 includes a transceiver. The user interface device 140 is commonly provided as a wireless device to allow it to be installed in the home without running wire, such as by affixing it to a wall or placing it on a table, for instance. The control panel 110 generally is a larger component that may be installed in an unobtrusive location in the home, such as a closet or basement. However, it is not necessary for the user interface device 140 to be separate from the control panel 110 as the user interface device 140 may be integrated into the control panel 110.

Various other components may communicate with the control panel 110, such as a wireless key fob 123 that is used to trip an alarm. The control panel 110 may also transmit signals to components of the security system 100. For example, signals may be transmitted to a siren 120 to activate the siren when an alarm condition is detected. Signals may be sent to the user interface device 140 to display status information to the user, such as whether the system is armed or disarmed, or whether a specific door or window has been opened. The control panel 110 may also have the ability to notify a monitoring service of an alarm condition via a communication interface 122, which may be a telephone dialer or interface to a computer network, for instance. The interface 122 may also allow the security system 100 to send and receive data for other purposes. For example, settings in the control panel 110 may be configured or changed remotely over a phone line or computer network connection. These settings include adjustments to the motion sensor's sensitivity. For example, if a motion sensor has a continuous false alarm tripping problem, the remote monitoring service may lower the sensitivity of the motion sensor from its remote location. An example of remote configuring software is the Ademco Compass software. The interface 122 may receive instructions from a remote device that is configured appropriately for communicating with the control panel 110. Such a remote device may have a control, memory and transmitter or transceiver. The interface 122 provides the instructions to the control panel 110, which in turn communicates with the motion sensor 125 to adjust its sensitivity.

The components of the security system 100 may communicate via wires routed through walls, ceilings and the like, and/or via wireless signals. One wireless system uses RF signals at 345 MHz to provide a nominal indoor range of 200 feet. The motion sensors 125, fire sensors 130, and window and door sensors 135 typically only transmit back to the control panel 110 when they are tripped, while the siren 120 only receives a signal from the control panel 110 when the control panel 110 detects an alarm condition based on a signal received from one of the sensors. However, in accordance with the invention, the motion sensor 125 has a receive capability, described further below, to allow remote adjustment of its sensitivity. The user interface device 140 may have both transmit and receive capabilities to communicate with the control panel 110. Different manufacturers may use different proprietary schemes for communicating data, such as different coding and modulation techniques may be used. Components provided by Honeywell Corp. may advantageously be used.

The control panel 110 includes a transceiver (transmitter and receiver) 112 for transmitting and receiving wired and/or wireless signals. The control 114 may include a microprocessor that executes software, firmware, micro-code or the like to implement logic to control the security system 100. The control panel 110 may include a non-volatile memory 115 and other additional memory 116 as required. A memory resource used for storing software or other instructions that are executed by the control 114 to achieve the functionality described herein may be considered a program storage device. A dedicated chip such as an ASIC may also be used. Generally, each wireless component of the security system must be “learned” by the control 114. In the learning process, data is stored in the non-volatile memory 115 that identifies the characteristics of each sensor, including the sensor type, serial number or other identifier, and what type of action to take based on signals received from each sensor. For example, the action may be to provide a status message to the user, store data for subsequent maintenance purposes, or trip an alarm. A power source 118 provides power to the control panel 110 and typically includes a battery backup to AC power.

As mentioned above, the motion sensor 125 has a receive capability to allow remote adjustment of its sensitivity. For example, the user interface 140 may transmit a signal to the motion sensor 125 to adjust its sensitivity. This signal can be communicated directly from the user interface device 140 or via the transceiver 112, via a wired or wireless path. Furthermore, a remote transmitter 200 may transmit an adjustment signal to the motion sensor 125, either directly or via the transceiver 112. Also, as mentioned, the communication interface/telephone dialer 122 may receive instructions via a telephone or computer network for adjusting the sensitivity of the motion sensor 125. The instructions are processed by the control panel 110, for example, and a signal is sent by the control panel 110 to the motion sensor 125 for adjusting its sensitivity accordingly.

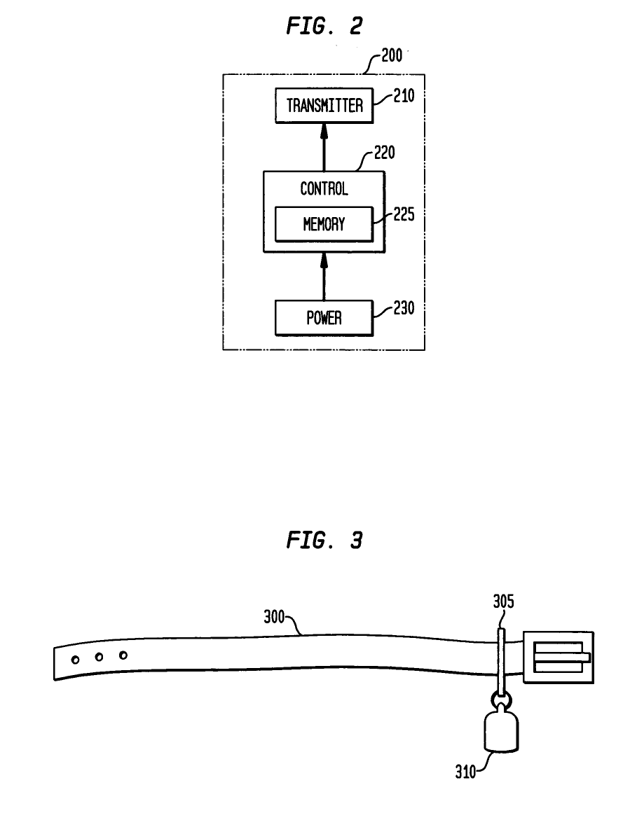

FIG. 2 illustrates a remote transmitter according to the invention. The remote transmitter 200 may include a transmitter 210 for transmitting wireless signals for instructing the motion sensor 125 to adjust its sensitivity, a control 220 with memory 225 for controlling the transmitter 210, and a power source 230 such as a battery for powering the control 220 and the transmitter 210. The control 220 may include a microprocessor that executes software, firmware, micro-code or the like to implement logic to control the remote transmitter 200. A memory resource 225 used for storing software or other instructions that are executed by the control 220 to achieve the functionality described herein may be considered a program storage device. A dedicated chip such as an ASIC may also be used.

FIG. 3 illustrates a pet collar with a remote transmitter according to the invention. In one possible scenario, the remote transmitter 200 is carried by a pet in the home, such as in a portable housing 310 attached to a loop 305 of a collar 300 (FIG. 3). The housing 310 can be of any design. The housing may open to allow a battery to be replaced, and may have an on-off switch which allows it to be turned off when not in use. The remote transmitter transmits a signal to the motion sensor 125 to lower its sensitivity so that an alarm is not triggered when the pet moves around in a room in which the motion sensor 125 is installed. The signal of the remote transmitter 200 should have a sufficient range and power so it can be received by the motion sensor. Moreover, the remote transmitter 200 should transmit either continuously or frequently enough so that the motion sensor 125 receives the signal before informing the control panel 110 that an intrusion has been detected. For example, if the motion sensor 125 takes three seconds to decide whether an intruder is present, the remote transmitter may transmit every second or so to allow a sufficient safety margin to avoid a false alarm, while also reducing power consumption in the remote transmitter 200.

It is also possible for a remote transceiver to be used in place of the remote transmitter 200, which receives a challenge signal from the motion sensor 125 when the intruder, e.g., a living being such as a pet or a human, is detected. If the remote transceiver responds back to the motion sensor 125 with an appropriate code, and within a specified time limit, no alarm is triggered. If the motion sensor 125 receives no response, an alarm is triggered.

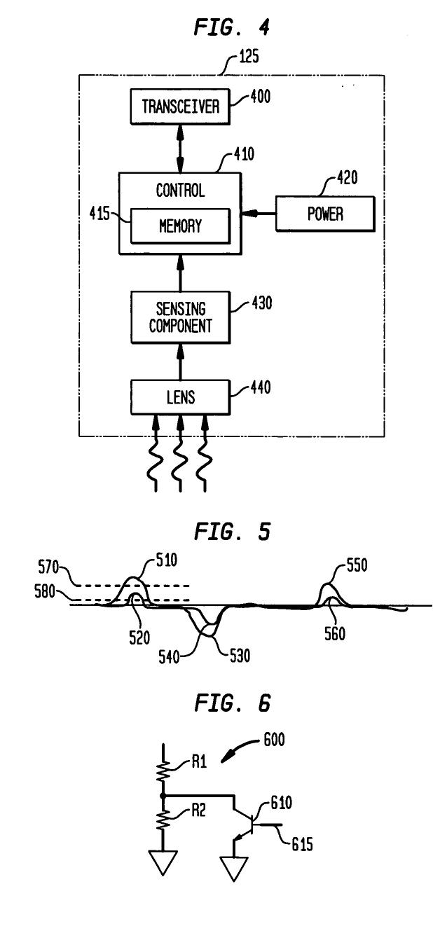

FIG. 4 illustrates a motion sensor with adjustable sensitivity according to the invention. The motion sensor 125 is shown as a passive infrared (PIR) sensor. However, other types of sensors may be used as well, including active sensors and dual mode sensors that include both passive and active components. The example motion sensor 125 receives infrared electromagnetic (EM) radiation via one or more lenses 440 and one or more sensing components 430, such as an infrared photo detector. The sensing component 430 converts the sensed EM radiation into an electrical signal that is processed by a control 410 with working memory 415. The control 410 determines whether to send a signal to the control panel 110 via the transceiver 400 to trigger an alarm based on the sensed radiation. The transceiver 400 allows the motion sensor 125 to receive commands for adjusting its sensitivity, e.g., from the remote transmitter 200 or the user interface device 140.

The motion sensor 125 includes a power source 420 such as a battery or a connection to the AC power in a building for powering the control 410 and the transceiver 400. The control 220 may include a microprocessor that executes software, firmware, micro-code or the like to implement logic to control the motion sensor 125. The memory resource 415 is a program storage device that may be used for storing software or other instructions that are executed by the control 410 to achieve the functionality described herein. A dedicated chip such as an ASIC may also be used.

There are a number of different ways for the motion sensor 125 to adjust its sensitivity in response to a remotely-transmitted signal. One way is by adjusting the pulse count. A sensitive PIR sensor will trigger an alarm on one pulse count. To lower the sensitivity, the control 410 can be configured so that the pulse count is increased, e.g., to require two or more pulses before triggering an alarm. A pulse is generated when an intruder passes through a sensitive zone. Specifically, the optical element, e.g., the sensing component 430, of a PIR motion sensor typically includes two sensing elements connected in a voltage-bucking configuration to cancel signals caused by vibration, temperature changes and sunlight. One of the sensing elements outputs a positive voltage pulse when a radiation source such as a living being passes in front of it, while the other sensing element outputs a negative voltage pulse when a living being passes in front of it. The sensing elements may be arranged on a horizontal plane so that they are sequentially exposed to the radiation source as the living being moves across a room, for example.

The positive and negative sensing elements are projected out of the motion sensor through lenses 440. Although very small internally, they become larger (as does the gap between them) as one moves a greater distance away from the motion sensor. A pulse count of one requires someone to cross in front of only one of the sensing elements (either positive or negative). A pulse count of two requires someone to cross in front of either a positive or a negative band, then through a dead spot between the bands, and then through the second band. A pulse count of three requires a person to cross in front of either a positive or negative band, then through the dead spot, then through the second band, then through another dead spot, and then through any other band of either polarity.

For example, FIG. 5 illustrates voltage pulses, and a detection threshold, according to the invention. Pulses 510 and 550 are positive voltage pulses corresponding to detection of a human, while pulse 530 is a related negative voltage pulse. Pulses 520 and 560 are positive voltage pulses corresponding to the detection of a pet, while pulse 530 is a related negative voltage pulse. The pulse count thus is a decision parameter that can be updated in the control 410, e.g., according to a signal received from the remote transmitter 200 or the remote user interface device 140. The remote adjustment of the pulse count used by the control 410 can be achieved using any type of communication and control algorithm.

Another way to lower a motion sensor's sensitivity is to lower the gain/threshold, which defines the electrical sensitivity. This can be accomplished, e.g., by adjusting the level at which the motion sensor 125 detects a pulse. For example, the control 410 may apply a detection threshold as a detection parameter to a signal from an analog to digital converter input that is being detected. The detection threshold can be adjusted internally within the motion sensor to be higher or lower. For example, the threshold 580 is relatively low since it detects the lower amplitude pulse 520 caused by detection of the pet. The threshold 570 is relatively high since it is higher than the lower amplitude pulse 520 from the pet, but it still results in the detection of the higher amplitude pulse 510 from the human. Thus, by raising the threshold, the sensitivity of the motion detector 125 can be decreased, e.g., so that it does not trigger an alarm when a pet is present. It may also be desirable to lower the sensitivity of the motion detector if it is detecting movement in an area of a home where detection is not desired, such as in an adjacent room or hallway. Similarly, by lowering the threshold, the sensitivity of the motion detector 125 is increased.

FIG. 6 illustrates a circuit 600 for adjusting a detection threshold, according to the invention. The circuit may be used for adjusting the pulse detection level as discussed above in connection with FIG. 5. For example, the circuit may be an external ladder network with resistors R1 and R2 that set the detection level. A transistor 610 may be used to remove or add resistors to change the detection level. Specifically, when the transistor 610 is controlled to pass current, the resistor R2 will be bypassed. Otherwise, the resistor R2 is not bypassed. The control 410 may provide a voltage on line 615 that controls the transistor 610 accordingly.

One can also adjust the sensitivity of the motion sensor 125 by adjusting the optical gain, e.g., by varying the area of the optical elements. A reduced area results in less sensitivity. Or, a filter can be moved into a position in front of the radiation detection element so it becomes less sensitive. Various techniques for implementing this feature are believed to be within the purview of a person skilled in the art. It may also be possible to adjust the sensitivity of one or more different detection bands of a motion sensor, depending on the configuration of the motion sensor.

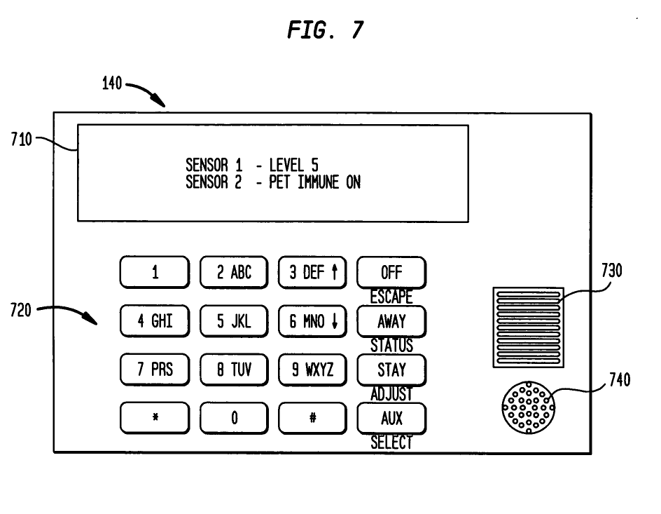

FIG. 7 illustrates a user interface device for remotely adjusting the sensitivity of a motion sensor, according to the invention. As mentioned, the user interface device 140 can be provided, e.g., as a peripheral to, or a part of, the main control panel 110. The exact arrangement of components is transparent to the user. Thus, the functionality that is described herein as being provided by a user interface device may be provided wholly locally to the device 140, or partially remotely, such as at the associated control panel 110. The user interface device 140 may include a user input component such as a keypad 720 and/or microphone 740 for speech recognition in a voice-activated system, and a user output component such as a display 710 and/or speaker 730. The display 710 may be a multi-line, multi-character LCD display, for instance. The display 710 can provide a graphic device such as a cursor or other highlight to allow the user to select a particular motion sensor or a room in a house or other building where one or more motion sensors are installed, using a “select” key to obtain additional information or options. In the example shown, the display 710 indicates that a first motion sensor has a sensitivity level of 5, e.g., on a scale of one through ten, and that a second motion sensor is configured in a “pet immune on” mode, which means the sensitivity of the motion sensor 125 is reduced to avoid triggering an alarm when a pet is present.

Advantageously, the user interface device 140 may be of the type that is used for controlling a home security system so no re-design, e.g., to provide additional keys on the keypad 420 is necessary. In particular, functions can be assigned to existing keys to accommodate the functionality of the present invention. Each key can have more than one function as well by employing double function or soft keys. In one possible example, the “off” key has the additional function of “escape”, the “away” key has the additional function of “status”, the “stay” key has the additional function of “adjust”, and the “aux” or auxiliary key has the additional function of “select”. Each of the additional functions can be accessed by pressing a “shift” or “function” key or the like, or by simply entering a specific mode. Optionally, dedicated keys can be provided for adjusting and monitoring the sensitivity level of the motion sensors.

Control logic associated with the user interface device 140 allows it to control both the conventional home or other building security system components, while also communicating with the motion sensor 125 of the invention to send commands to the motion sensor, such as to change the sensitivity, and receive status information from the motion sensor, such as the current sensitivity setting. Any appropriate menu display scheme and logic may be used. In one possible scenario, a technician or other user remotely adjusts the sensitivity of the motion sensor to an optimal level while carrying the portable user interface device 140 around a room. This makes the installation procedure much more convenient. If the user interface device 140 is not portable, a second person may be used to walk in front of the motion sensor while the first person adjusts the sensitivity to the optimal level. The user interface device 140 may also be used to set a schedule for varying the sensitivity of one or more motion sensors. For example, for homeowners who keep their pets outside the home during the daytime, and in the home at night, the sensitivity may automatically adjust so that it is less sensitive, or pet immune, at night.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. An apparatus for adjusting the sensitivity of a motion detector, comprising;
a transmitter; and
a control for controlling the transmitter to transmit a signal for adjusting the sensitivity of the motion detector.

2. The apparatus of claim 1, further comprising:
a user interface device for receiving a user command;
wherein the control is responsive to the user command received by the user interface device for controlling the transmitter to transmit the signal for adjusting the sensitivity of the motion detector.

3. The apparatus of claim 2, wherein:
the user command sets a schedule for controlling the sensitivity of the motion detector.

4. The apparatus of claim 2, wherein:
the user command sets a sensitivity level for the motion detector.

5. The apparatus of claim 1, wherein:
the signal for adjusting the sensitivity of the motion detector comprises a command to change a pulse count of the motion detector.

6. The apparatus of claim 1, wherein:
the signal for adjusting the sensitivity of the motion detector comprises a command to change an optical gain of the motion detector.

7. The apparatus of claim 1, wherein:
the signal for adjusting the sensitivity of the motion detector comprises a command to change a sensitivity of a sensing component of the motion detector.

8. The apparatus of claim 1, wherein:
the signal is a wireless signal.

9. The apparatus of claim 8, further comprising:
a portable housing in which the transmitter and control are provided.

10. The apparatus of claim 9, further comprising:
a pet collar for carrying the portable housing.

11. The apparatus of claim 9, further comprising:
a battery provided in the portable housing for powering the control and transmitter.

12. A motion detector, comprising;
a component for sensing electromagnetic radiation that is indicative of the presence of a living being;
a control responsive to the component for determining, in accordance with the sensed electromagnetic radiation, whether to trigger a signal indicating that the living being has been detected; and
a receiver for receiving a remotely-generated signal for adjusting a sensitivity of the motion detector;
wherein the control is responsive to the remotely-generated signal for adjusting a sensitivity with which the component senses the electromagnetic radiation.

13. The motion detector of claim 12, wherein:
the remotely-generated signal comprises a command to change an optical gain of the component.

14. The motion detector of claim 12, wherein:
the remotely-generated signal is a wireless signal.

15. The motion detector of claim 12, wherein:
the remotely-generated signal is responsive to an adjustment instruction received via a communication interface.

16. A motion detector, comprising;
a component for sensing electromagnetic radiation that is indicative of the presence of a living being;
a control responsive to the component for determining, in accordance with the sensed electromagnetic radiation and a decision parameter, whether to trigger a signal indicating that the living being has been detected;
a receiver for receiving a remotely-generated signal for adjusting a sensitivity of the motion detector;
wherein the control is responsive to the remotely-generated signal for adjusting the decision parameter.

17. The motion detector of claim 16, wherein:
the remotely-generated signal comprises a command to change a pulse count that the control uses as the decision parameter.

18. The motion detector of claim 16, wherein:
the remotely-generated signal is a wireless signal.

19. The motion detector of claim 16, wherein the remotely-generated signal is responsive to an adjustment instruction received via a communication interface.
